(19) United States
(12) Patent Application Publication
(10) Pub. No.: US 2022/0200404 A1
(43) Pub. Date: Jun. 23, 2022

(54) VIBRATION MOTOR

(71) Applicant: AAC Microtech (Changzhou) Co., Ltd., Changzhou City (CN)

(72) Inventor: Jie Ma, Shenzhen (CN)

(21) Appl. No.: 17/533,147

(22) Filed: Nov. 23, 2021

(30) Foreign Application Priority Data
Dec. 18, 2020 (CN) 202023080642.7

(51) Int. Cl. H02K 7/18; H02K 1/34; H02K 33/18

(52) U.S. Cl. CPC H02K 7/1876; H02K 5/04; H02K 33/18; H02K 1/34

(57) ABSTRACT

The present invention provides a vibration motor having a housing with an accommodation space; a stator having an iron core, a coil, and a yoke; and a vibrator. The vibrator includes a magnetic circuit system having a magnet group, and a pole plate arranged at a side of the magnet group away from the stator. The vibration motor further has an elastic support member supporting the vibrator, and an interval between the stator and the magnet group. The yoke is opposite to the magnet group, and includes a groove formed from a surface opposite to the magnet group away from the magnet group. One of the objects of the present invention is to provide a vibration motor which improves stability of the whole system and reduces negative stiffness.

### FIELD OF THE PRESENT DISCLOSURE

The present disclosure relates to motors, in particular to a vibration motor for providing tactile feedback.

### DESCRIPTION OF RELATED ART

With the rapid development of electronic technology, portable consumer electronic products, such as mobile phones, handheld game consoles, navigation devices, or handheld multimedia entertainment devices, are becoming more and more popular. These electronic products generally use linear motors for system feedback, such as mobile phone call prompts, information prompts, navigation prompts, and vibration feedback of game consoles.

The linear vibration motor in the prior art usually includes a housing with an accommodation space, a vibrator accommodated in the accommodation space, a stator and an elastic component that supports the vibrator. The stator includes an iron core, a coil provided outside the iron core, and a magnetic yoke provided at both ends of the iron core. The traditional yoke is flat. When the stator and the magnet are displaced relative to each other, there will be a difference between the yoke and the magnet pole surface. This leads to a difference between the static suction of the yoke and the two-pole magnet, and the difference shows a negative stiffness related to the relative displacement.

Therefore, it is necessary to provide a new linear vibration motor to solve the above-mentioned defects in the prior art.

### SUMMARY OF THE PRESENT INVENTION

One of the objects of the present invention is to provide a vibration motor which improves stability of the whole system and reduces negative stiffness.

To achieve the above-mentioned objects, the present invention provides a vibration motor having a housing with an accommodation space; a stator having an iron core, a coil set around the iron core, and a yoke disposed on both ends of the iron core; and a vibrator accommodated in the accommodation space.

The vibrator includes a magnetic circuit system having a magnet group arranged at two ends of the stator, and a pole plate arranged at a side of the magnet group away from the stator. The vibration motor further comprises an elastic support member supporting the vibrator, and an interval between the stator and the magnet group. The yoke is opposite to the magnet group, and includes a groove formed from a surface opposite to the magnet group away from the magnet group.

Further, the two yokes are symmetrically arranged at both ends of the iron core.

Further, the groove is formed by a first inclined surface and a second inclined surface connecting to and symmetrical with the first inclined surface.

Further, the groove is V-shaped.

Further, the magnet group includes a first magnet and a second magnet parallel to the first magnet; the first and second magnets have opposite magnetic poles; a projection of the groove on the magnet group along a vibration direction falls on the first magnet and the second magnet.

Further, the vibrator further includes a weight with a through hole for receiving the magnetic circuit system with the pole plate attached to an inner surface of the through hole.

Further, the elastic support member includes a pair of elastic support arms surrounding the weight and respectively fixedly connected with the housing and the weight for suspending the weight in the accommodation space.

Further, the housing includes a bottom plate and an upper cover cooperatively forming the accommodation space; while the bottom plate includes a position limiting block corresponding to the elastic support member.

Further, an amount of the position limiting block is two; the two position limiting blocks are corresponding to the elastic support arm.

Further, the elastic support arm has a position avoiding part corresponding to the position limiting block.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric view of a linear vibration motor in accordance with an exemplary embodiment of the present invention;

FIG. 2 is an isometric view of the linear vibration motor in FIG. 1 with an upper cover thereof being disassembled;

FIG. 3 is an isometric view of the linear vibration motor in FIG. 1 with an upper cover thereof being disassembled, from another aspect;

FIG. 4 is an exploded view of the linear vibration motor in FIG. 1;

FIG. 5 is an assembled view of a stator and a magnetic circuit system of the vibration motor.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby is only to explain the disclosure, not intended to limit the disclosure.

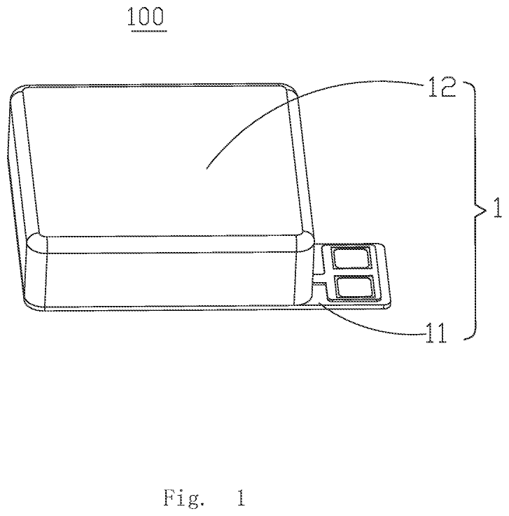

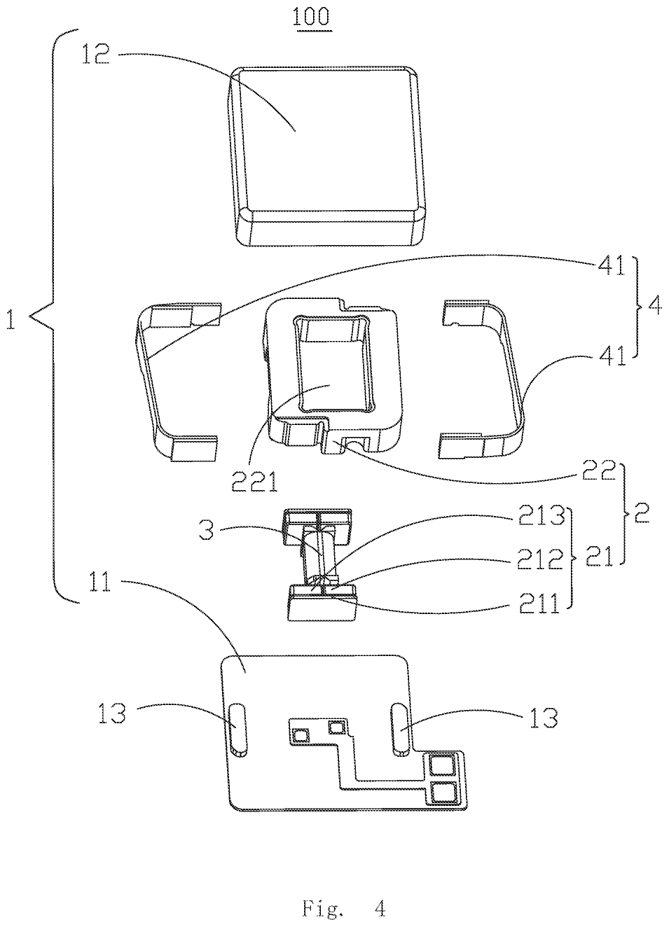

Please refer to FIG. 1 and FIG. 4, a linear vibration motor 100 is provided by the present invention. the linear vibration motor 100 includes a housing 1 with accommodation space, a vibrator 2 accommodated in the accommodation space in the housing 1, a stator 3, and an elastic support member 4 supporting the vibrator 2. The elastic support member 4 supports the vibrator 2 to reciprocate in the accommodation space to generate vibration.

The housing 1 includes a bottom plate 11 and an upper cover 12 assembled with the bottom plate 11. The bottom plate 11 and the upper cover 12 are combined to form an accommodation space. The vibrator 2 includes a weight 22 with a through hole 221 in the middle and a magnetic circuit system 21 accommodated in the through hole 221. The elastic support member 4 surrounds outside the weight 22 and fixedly connected to the housing 1 and the weight 22 respectively to suspend the weight 22 in the accommodation space.

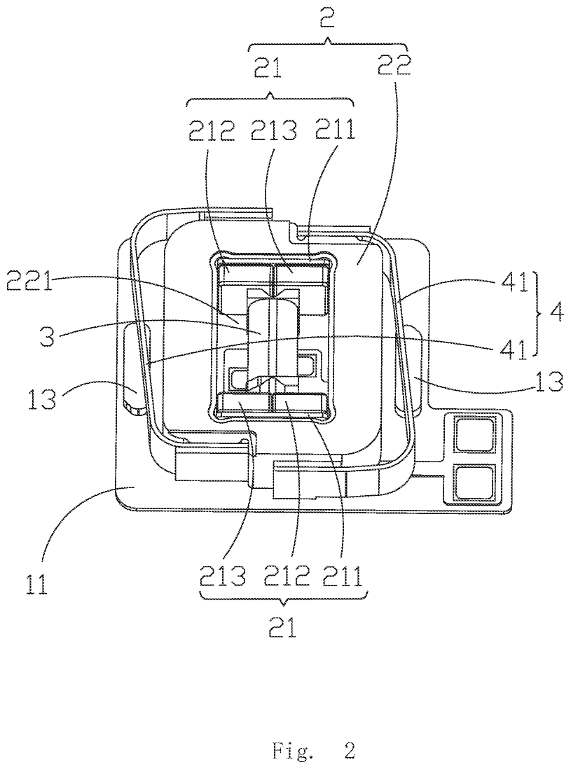

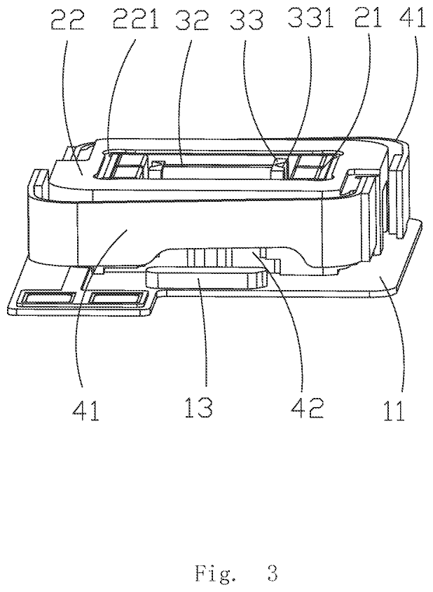

In an alternative embodiment, please refer to FIGS. 2-5, the magnetic circuit system 21 is arranged and surrounds outside the stator 3 and spaced apart from the stator 3. Two sets of magnet groups located at the two ends of the stator 3 and a pole plate 211 located on the side of the magnet group away from the stator 3 are included. The number of the pole plate 211 is two corresponding to the magnet group. And the pole plate 211 is attached to the inner surface of the through hole 221 in the weight 22. Each of the magnet group includes a first magnet 212 and a second magnet 213 arranged in parallel. The polarities of the first magnet 212 and the second magnet 213 are opposite. In the embodiment of the present invention, the first magnet 212 and the second magnet 213 have the same size, and both are rectangular. The first magnet 212 and the second magnet 213 form a rectangular magnet group. The magnet groups at both ends are set opposite to each other. And the first magnet 212 in the magnet group at one end is opposite to the second magnet 213 in the magnet group at the other end.

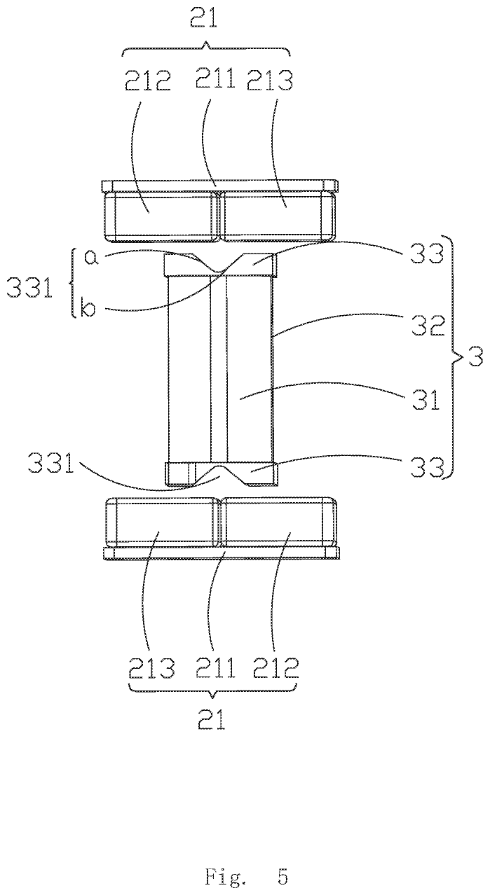

In an alternative embodiment, please refer to FIGS. 4-5, the stator 3 includes an iron core 31, a coil 32 sleeved on the iron core 31, and a yoke 33 disposed on both ends of the iron core 31. At each end of the iron core 31, the yoke 33 is opposite to the magnet group and arranged at intervals, and the yoke 33 is also provided with a groove 331 opposite to the magnet group. The groove 331 is formed concavely from the surface on the side opposite to the magnet group away from the magnet group. Preferably, the two yokes 33 are symmetrically arranged with the two ends of the iron core 31. The groove 331 includes a first inclined plane a and a second inclined plane b which are connected. And the first inclined plane a and the second inclined plane b are arranged symmetrically. Preferably, the groove 331 is a symmetrical V-shape. Preferably, the groove 331 is arranged opposite to the first magnet 212 and the second magnet 213, and the projection part of the groove 331 on the magnet group along the vibration direction falls on the first magnet 212 and the second magnet 213.

In an alternative implementation manner, please refer to FIGS. 2-4. The elastic support member 4 includes a pair of the elastic support arm 41. A pair of the elastic support arm 41 is arranged and surround outside the weight 22. And the elastic support arm 41 is connected to the housing 1 on one side, and the weight 22 on the other side. In this way, the weight 22 is suspended in the accommodation space in housing 1. Optionally, a pair of the elastic support arm 41 is arranged symmetrically in the center.

In an alternative embodiment, please refer to FIGS. 1 to 4, the bottom plate 11 includes two position limiting blocks 13 corresponding to the elastic support arm 41, for limiting the relative positions of the elastic support arm 41 and the bottom plate 11. Avoidance part 42 is provided on elastic support arm 41. The avoidance part 42 is formed as a recess from the surface of the elastic support arm 41 close to the bottom plate 11 to away from the bottom plate 11. Optionally, two position limiting blocks 13 are set symmetrically.

Compared with the related art, the linear vibration motor 100 of the present invention is provided with a groove 331 on the yoke 33 at both ends of the iron core 31. The groove 331 is arranged opposite to the magnet group. In this way, during the vibration of the linear vibration motor 100, when the stator 3 and the magnet group are displaced relative to each other, it is ensured that the area of the yoke 33 facing the magnet group is almost unchanged. Furthermore, there is almost no difference between the static suction of the yoke 33 and the two magnet groups, which can effectively reduce the negative stiffness.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A vibration motor, comprising:
a housing with an accommodation space;
a stator having an iron core, a coil set around the iron core, and a yoke disposed on both ends of the iron core;
a vibrator accommodated in the accommodation space, including a magnetic circuit system having a magnet group arranged at two ends of the stator, and a pole plate arranged at a side of the magnet group away from the stator;
an elastic support member supporting the vibrator;
an interval between the stator and the magnet group;
wherein
the yoke is opposite to the magnet group, and includes a groove formed from a surface opposite to the magnet group away from the magnet group.

2. The linear vibration motor as described in claim 1, wherein, the two yokes are symmetrically arranged at both ends of the iron core.

3. The linear vibration motor as described in claim 1, wherein, the groove is formed by a first inclined surface and a second inclined surface connecting to and symmetrical with the first inclined surface.

4. The linear vibration motor as described in claim 3, wherein, the groove is V-shaped.

5. The linear vibration motor as described in claim 1, wherein, the magnet group includes a first magnet and a second magnet parallel to the first magnet; the first and second magnets have opposite magnetic poles; a projection of the groove on the magnet group along a vibration direction falls on the first magnet and the second magnet.

6. The linear vibration motor as described in claim 1, wherein, the vibrator further includes a weight with a through hole for receiving the magnetic circuit system with the pole plate attached to an inner surface of the through hole.

7. The linear vibration motor as described in claim 6, wherein, the elastic support member includes a pair of elastic support arms surrounding the weight and respectively fixedly connected with the housing and the weight for suspending the weight in the accommodation space.

8. The linear vibration motor as described in claim 7, wherein, the housing includes a bottom plate and an upper cover cooperatively forming the accommodation space; while the bottom plate includes a position limiting block corresponding to the elastic support member.

9. The linear vibration motor as described in claim 8, wherein, an amount of the position limiting block is two; the two position limiting blocks are corresponding to the elastic support arm.

10. The linear vibration motor as described in claim 9, wherein, the elastic support arm has a position avoiding part corresponding to the position limiting block.
